(19) United States
(12) Patent Application Publication
(10) Pub. No.: US 2016/0223770 A1
(43) Pub. Date: Aug. 4, 2016

(54) FIBER OPTIC TERMINATION ASSEMBLY

(71) Applicants: TYCO ELECTRONICS RAYCHEM BVBA, Kessel-Lo (BE); ADC CZECH REPUBLIC S.R.O., Brno (CZ)

(72) Inventors: Johan GEENS, Bunsbeek (BE); David NOAK, Trest (CZ)

(21) Appl. No.: 15/021,878

(22) PCT Filed: Sep. 12, 2014
(86) PCT No.: PCT/EP2014/069509

§ 371 Date: Mar. 14, 2016

Related U.S. Application Data
(60) Provisional application No. 61/877,770, filed on Sep. 13, 2013.

(51) Int. Cl. G02B 6/44

(52) U.S. Cl. CPC G02B 6/4455; G02B 6/4452

(57) ABSTRACT

A fiber optic termination assembly (10) includes a chassis (12) which holds a plurality of pivotally mounted trays (14) in a stacked array. The trays (14) and chassis (12) allow selective access to each tray (14) as desired by pivoting a selected tray (12) relative to the chassis (12). The tray (14) includes a base part (40) and a detachable part (42). The base part (40) remains with the chassis (12), and the detachable part (42) is separable from the base part (40). The base part (40) cooperates with the detachable part (42) to form a cable storage area (74) for storing one or more loops of fiber optic cables. The detachable part (42) includes a termination panel (110) for holding a plurality of adapters (112) wherein the adapters allow for mating of two connectors (114) for fiber optic signal transmission. The detachable part (42) may also include a cable storage area and/or a cable splice area.

### CROSS-REFERENCE TO RELATED APPLICATION(S)

This application claims priority to U.S. Patent Application Ser. No. 61/877,770 filed on Sep. 13, 2013, the disclosure of which is incorporated herein by reference in its entirety.

### BACKGROUND OF THE INVENTION

A fiber optic termination assembly allows for fiber optic cables to be connected to other fiber optic cables through a termination panel including a plurality of adapters. Sometimes feeder cables are connected directly to distribution cables. In other examples, patch cords are utilized to connect patch fields between distribution and feeder cables. In some systems, cable storage and cable splicing may be provided. Improvements in this area are desired.

### SUMMARY OF THE INVENTION

One aspect of the present invention includes a fiber optic termination assembly including a chassis which holds at least one pivotally mounted tray, and alternatively a plurality of pivotally mounted trays in a stacked array. The trays and chassis allow selective access to each tray as desired by pivoting a selected tray relative to the chassis. The tray includes a base part and a detachable part. The base part remains with the chassis, and the detachable part is separable from the base part. The base part cooperates with the detachable part to form a cable storage area for storing one or more loops of fiber optic cables. The detachable part includes a termination panel for holding a plurality of adapters wherein the adapters allow for mating of two connectors for fiber optic signal transmission. The detachable part may instead or in addition to also include a cable storage area and/or a cable splice area.

### BRIEF DESCRIPTION OF THE FIGURES

FIG. 1 is a perspective view of a fiber optic termination assembly in accordance with aspects of the present invention;

FIG. 2 is a front view of the fiber optic termination assembly of FIG. 1;

FIG. 3 is a top view of the fiber optic termination assembly of FIG. 1;

FIG. 4 is a perspective view of the fiber optic termination assembly of FIG. 1, with portions removed, and showing a single tray;

FIG. 5 is a further view of the assembly of FIG. 4, without the top cover, and with a front cover pivoted away from the tray;

FIG. 6 is a view like FIG. 5, with the tray also pivoted out of the chassis;

FIG. 7 is a further perspective view of the assembly of FIG. 6, with the tray shown in a pivoted position, and showing a detachable part of the tray separate from a base part;

FIG. 8 is an enlarged view of one of snap fit connections between the base part and the detachable part of the tray;

FIG. 9 is an enlarged view of the tray latch and other features of the tray and frame;

FIG. 10 is an enlarged view like FIG. 9 from a different angle;

FIG. 11 is a perspective view of a tray removed from the chassis;

FIG. 12 is a top view of the tray of FIG. 11;

FIG. 13 is a bottom view of the tray of FIG. 11.

### DETAILED DESCRIPTION OF THE PREFERRED EMBODIMENTS

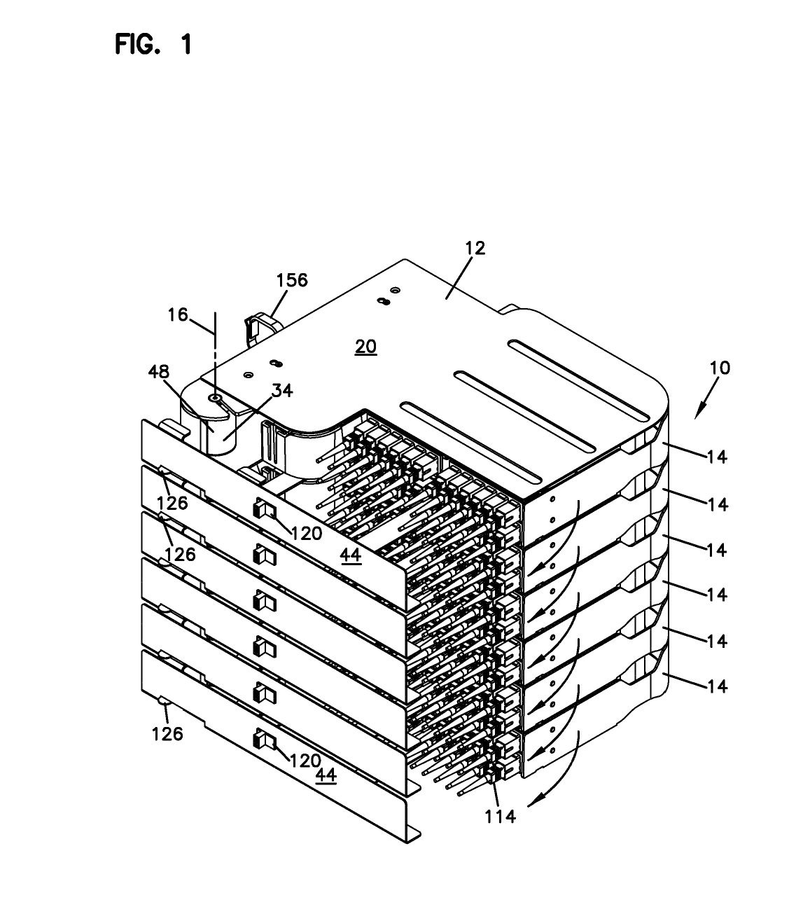

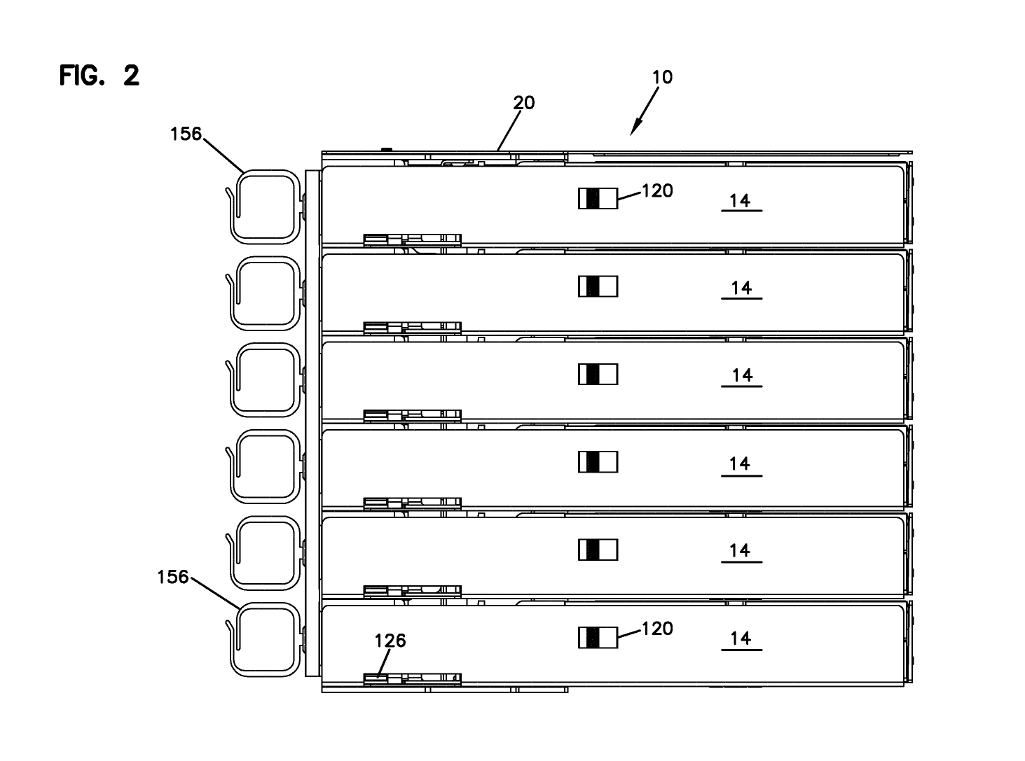

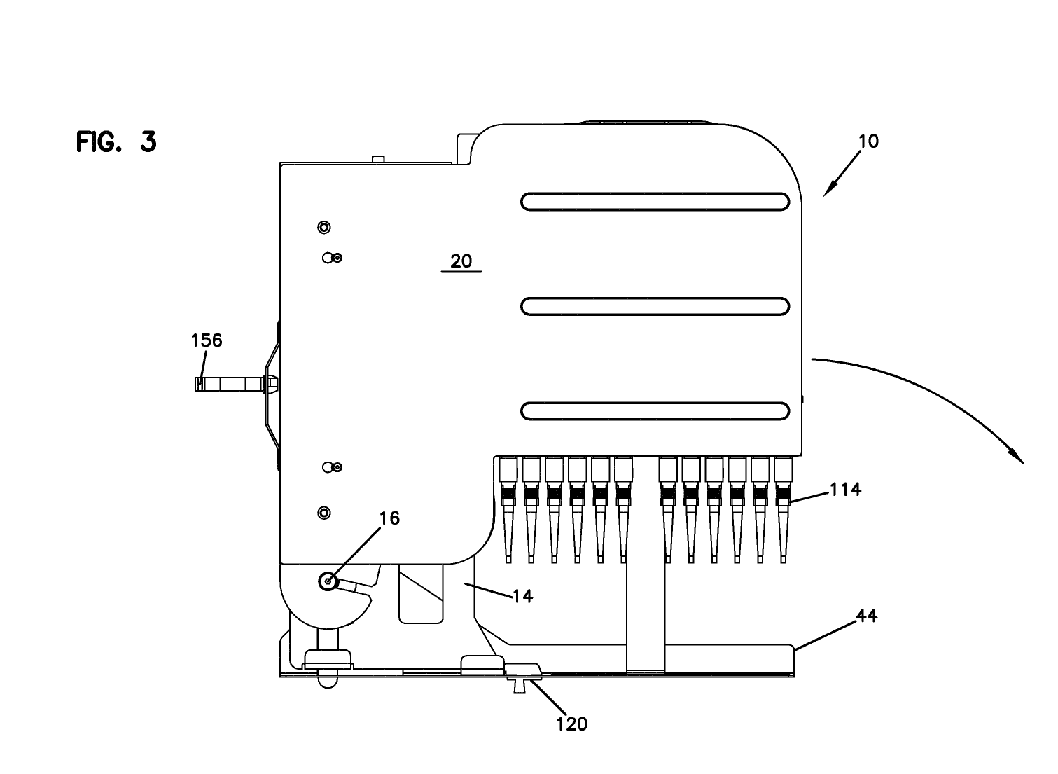

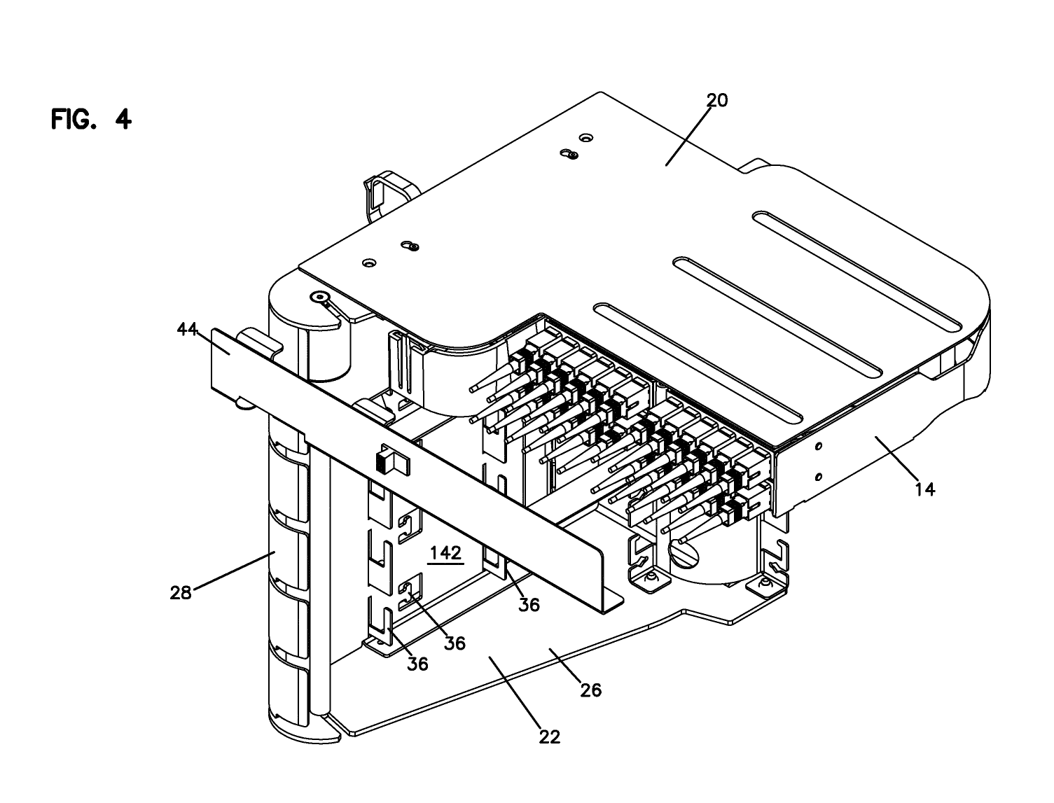

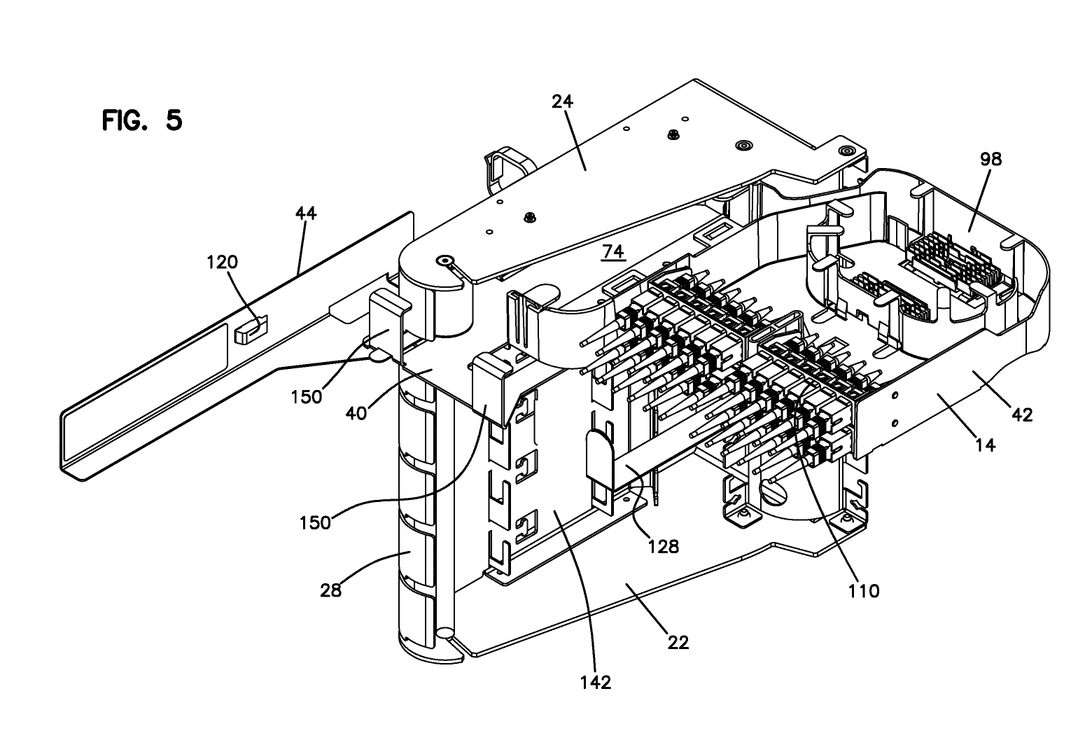

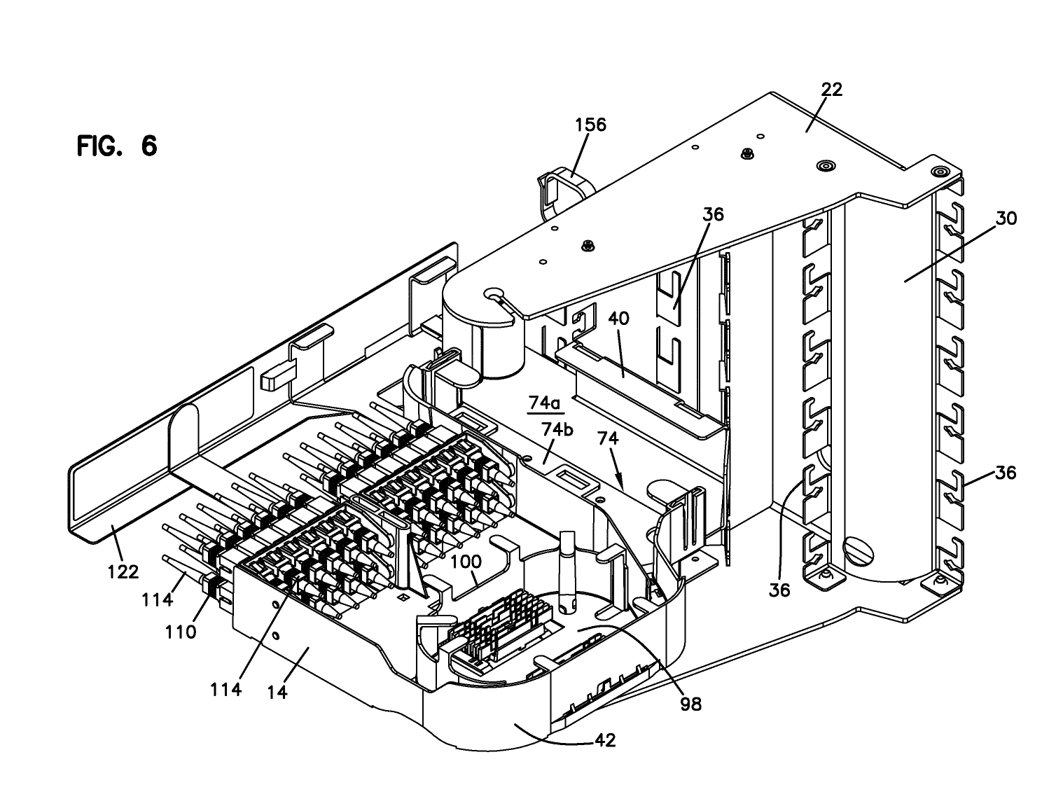

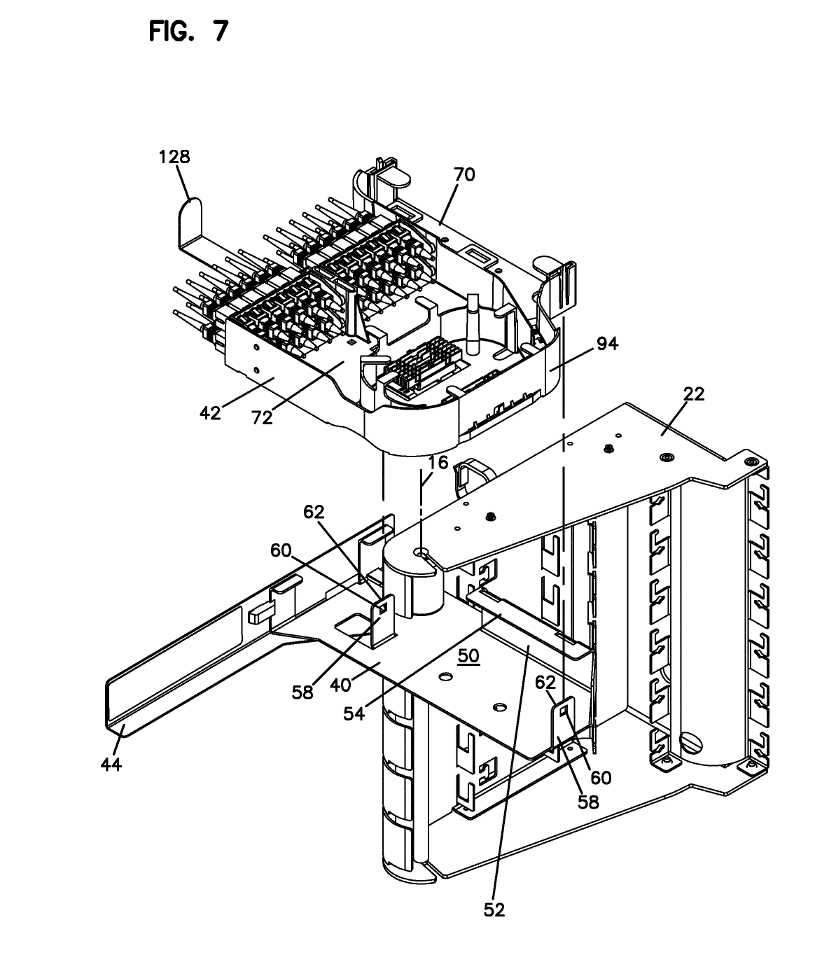

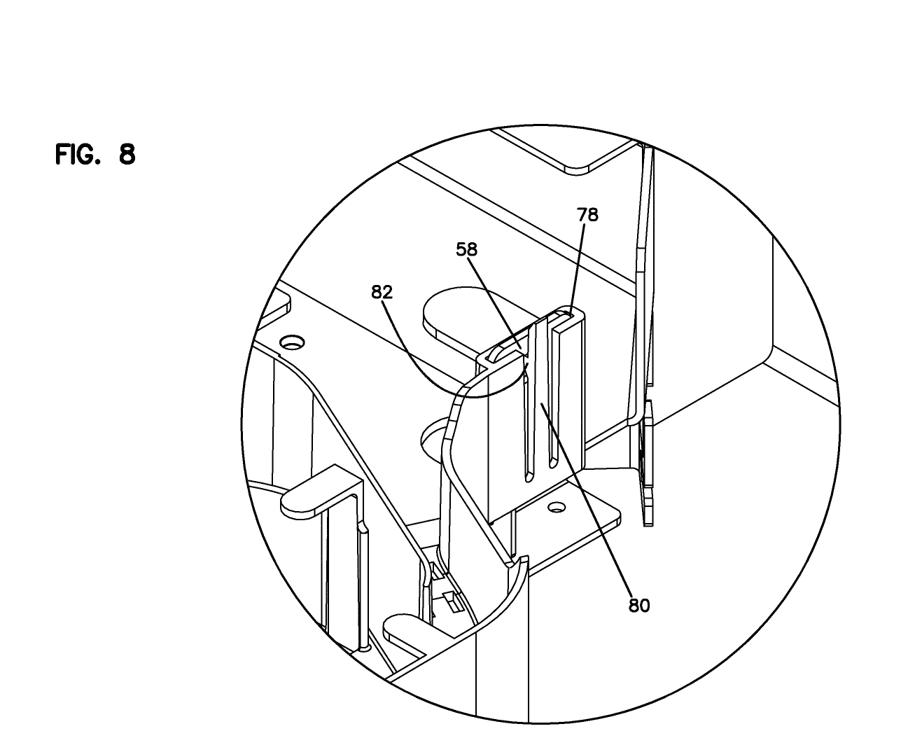

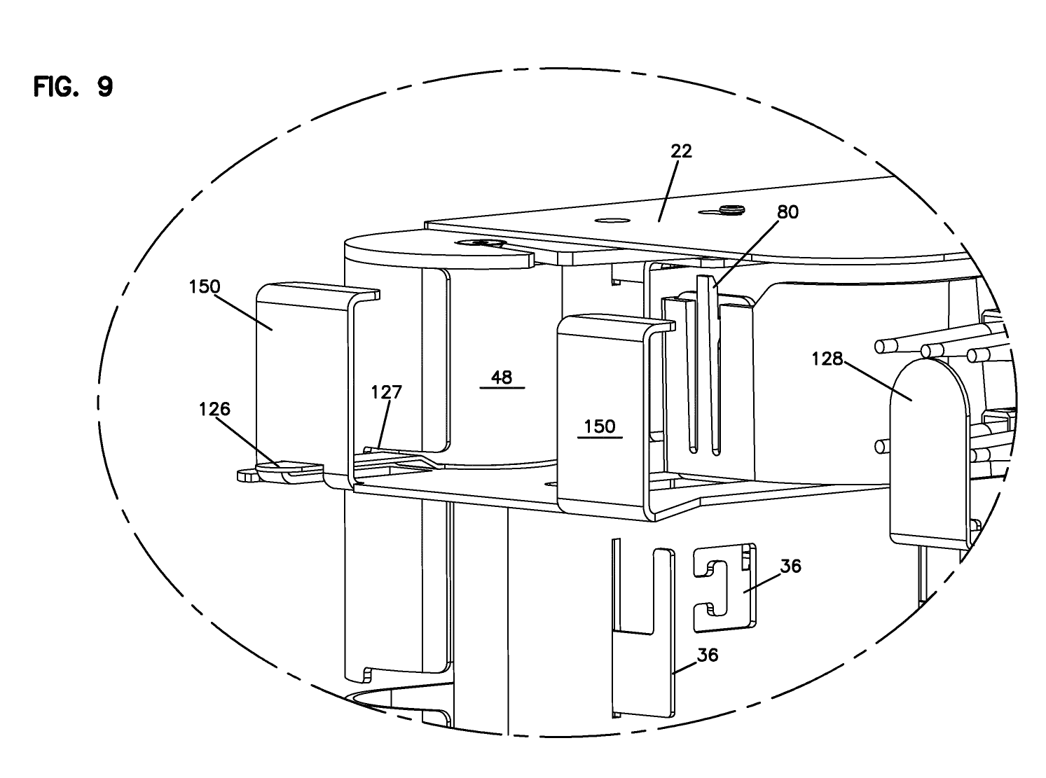

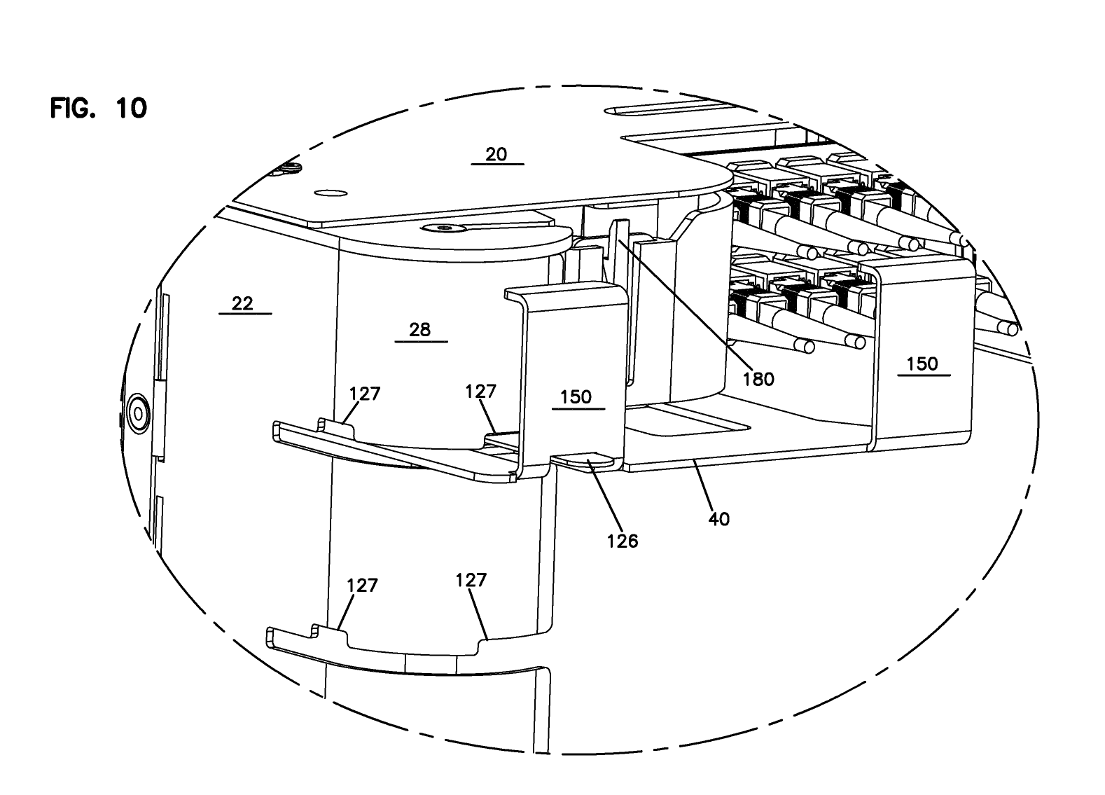

Referring now to FIGS. 1-10, a fiber optic termination assembly is shown including a chassis 12 and a plurality of trays 14. Trays 14 are pivotally rotatable about hinge axis 16 relative to chassis 12.

Chassis 12 includes a top 20 and a frame 22 having a top portion 24, a bottom portion 26 and a side portion 28. A rear portion 30 is also provided. Hinge 34 defines hinge axis 16 to allow pivoting movement of a selected tray 14 relative to chassis 12 to permit access to an interior of tray 14.

Frame 22 includes cable management elements 36 for holding incoming cables or fiber tubes inside of chassis 12. Elements 36 include hooks, tabs, ties, and other devices for guiding and managing cables or tubes.

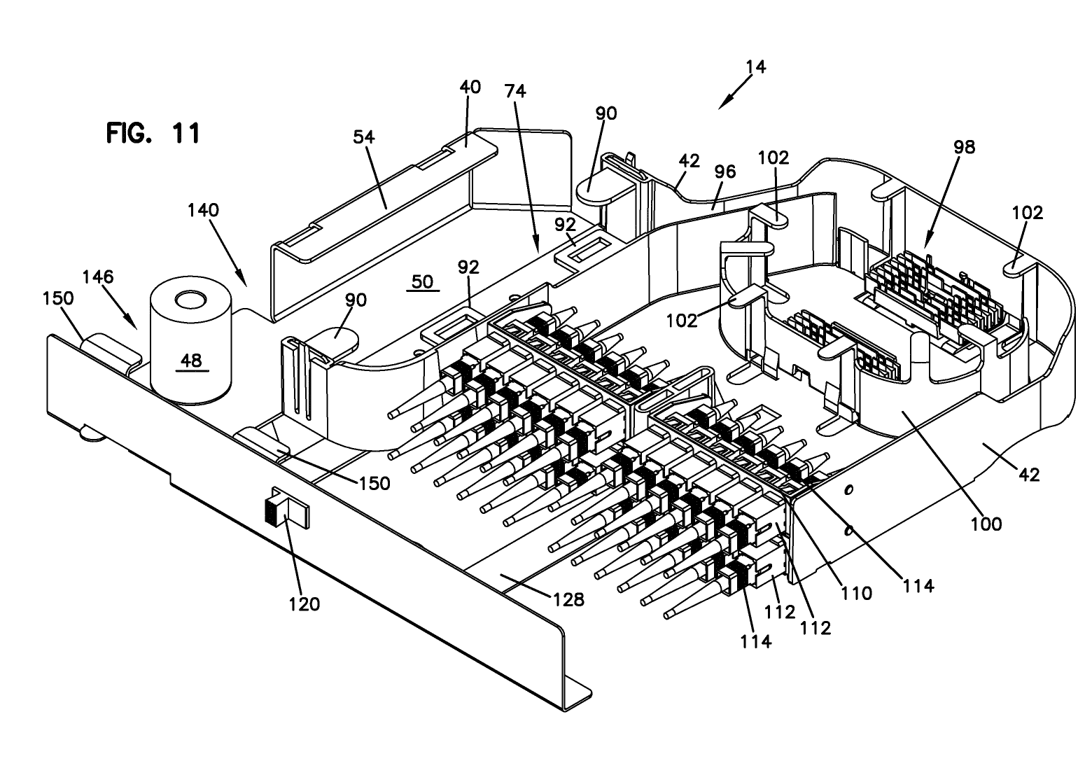

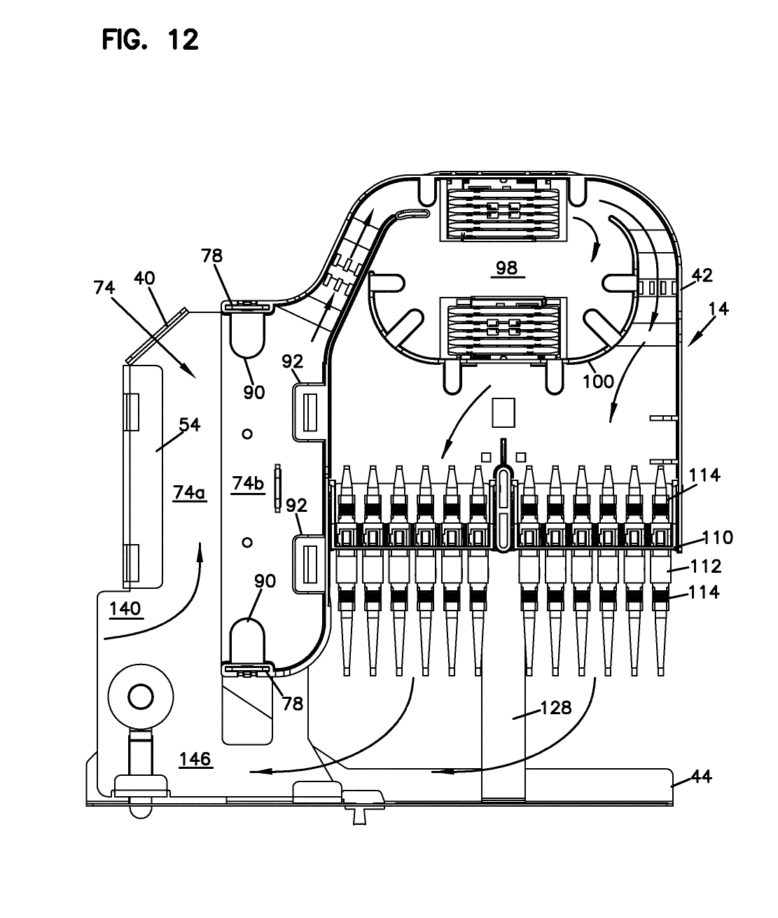

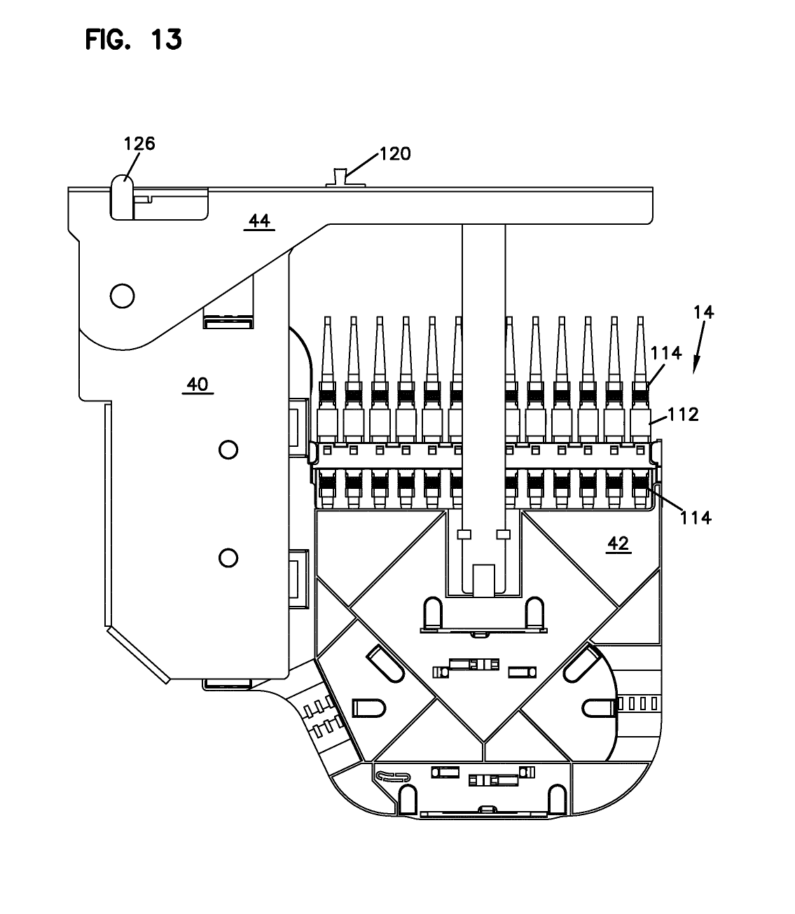

Referring to FIGS. 1-10 and also FIGS. 11-13, tray 14 includes a base part 40 and a detachable part 42. A front cover 44 covers a front area of tray 14, and is separately pivotable about hinge axis 16 relative to a remainder of tray 14.

Base part 40 is connected in a pivotable manner to frame 22 of chassis 12 at hinge element 48. Base part 40 includes a bottom 50, a side 52 and cable tab 54. Base part 40 further includes two projections 58 each defining a hole 60 in a distal end 62.

The detachable part 42 has a side portion 70 and a cable termination portion 72. Other functions besides terminations or in addition to terminations can be handled by portion 72. Side portion 70 cooperates with base part 40 to form a basket area 74 for storing loops of cable. Side portion 70 includes slots 78 which each receive one of projections 58 of base part 40. Flexible tabs 80 each including a projection 82 for engagement with holes 60 of projections 58 of base part 40 to retain detachable part 42 with base part 40. Side portion 70 includes first cable tabs 90 and second cable tabs 92 which cooperate with cable tab 54 of base part 40 to form a partially enclosed basket area 74 for storage of cable loops. Flexible tabs 80 allow for a quick connect of detachable part 42 to base part 40. Flexible tabs 80 also allow for a quick disconnect of detachable part 42 from base part 40. The flexible tabs 80 and projections 82 form a snap fit connection. Termination portion 72 is surrounded by a wall 94.

From basket area 74 a cable pathway 96 leads cables to a splice or a storage area 98. Various structures can be provided on cable termination portion 72 including splices and/or storage of cables. Various additional structures can be provided for managing and organizing the fiber optic cables, including a divider wall 100 and cable retention tabs 102. A termination panel 110 holds fiber optic adapters 112 which are used to align connectors 114 for transmission of fiber optic signals.

Front cover 44 includes a latch 120 which latches front cover to base part 40. Front cover 44 is separately rotatable relative to base part 40. Cover 44 includes a flange 122 which is positioned between hinge elements 48 in the stack of trays 14. Front cover 44 includes an opening for receipt of tray latch 126. Latch 126 is flexible and is able to hold tray 14 in a closed/retracted position or an open/extended position when latch 126 is positioned in notches 127.

Tray 14 also includes a front element 128 which supports cables on the front of tray 14. Cables enter tray 14 along pathway 140 and can be held by hooks and ties along wall section 142. Cables exit tray 14 along pathway 146 and support 128 and front flanges 150. The outgoing cables can be further supported by cable rings 156 along side portion 28 of frame 22.

The interior of chassis 12 can be accessed and a tray 14, by pivoting front cover 44 to an open position. This allows for access to front connectors 114 on a tray 14. If a rear connector 114 needs to be accessed the selected tray 14 can be pivoted can be pivoted out of chassis 12. Splice/storage area 98 can also be accessed when tray 14 is pivoted out from chassis 12.

If a technician needs to do work on a splice or other equipment in tray 14, detachable part 42 can be separated from base part 40. The slack cable in basket area 74 allows for the detachable part 42 to be moved to a table area or more convenient location for the technician to work on tray 14. Base part 40 stays with chassis 12. The storage loops of cable in basket area 74 tend to fall out as the detachable part 42 is moved away from base part 40. Flexible tabs 80 allow for a quick disconnect of detachable part 42 from base part 40. Flexible tabs 80 allow for a quick connect of detachable part 42 to base part 40. The slack cable can be looped up and placed back in basket area 74.

Basket area 74 is formed in part by first basket portion 74a of base part 40, and second basket portion 74b of detachable part 42. When detached, the cables stored in basket area 74 easily fall out to allow the technician to easily move detachable part 42 to an area away from chassis 12.

Typically, chassis 12 is mounted in a rack that may hold a column of chassis 12 that span floor to ceiling, or other equipment. By allowing the technician to move detachable portion 42 away from chassis 12 and undoing the storage loops from basket area 74, the technician can easily move, and more quickly perform the necessary service work.

The above specification, examples and data provide a complete description of the manufacture and use of the composition of the invention. Since many embodiments of the invention can be made without departing from the spirit and scope of the invention, the invention resides in the claims hereinafter appended.

### PARTS LIST

10 Fiber optic termination assembly
12 Chassis
14 Tray
16 Hinge axis
20 Top
22 Frame
24 Top portion
26 Bottom portion
28 Side portion
30 Rear portion
34 Hinge
36 Cable management elements
40 Base part
42 Detachable part
44 Front cover
48 Hinge element
50 Bottom
52 Side
54 Cable tab
58 Projections
60 Holes
62 Distal end
70 Side portion
72 Cable termination portion
74 Basket area
74a First basket portion
74b Second basket portion
78 Slots
80 Flexible tabs
82 Projections
90 First cable tabs
92 Second cable tabs
94 Wall
96 Cable pathway
98 Splice/storage area
100 Divider wall
102 Cable tabs
110 Termination panel
112 Adapters
114 Connectors
120 Latch
122 Flange
124 Opening
126 Tray latch
127 Notches
128 Support
140 Pathway
142 Wall section
146 Pathway
150 Front flanges
156 Cable rings

1. A fiber optic termination assembly comprising:
a chassis;
tray pivotally mounted to the chassis;
the tray including a base part and a detachable part;
wherein the base part remains with the chassis, and the detachable part is separable from the base part;
wherein the base part cooperates with the detachable part to form a cable storage area for storing one or more loops of fiber optic cables;
wherein the detachable part includes a termination panel for holding a plurality of adapters, wherein the adapters allow for mating of two connectors for fiber optic signal transmission and/or a cable splice area and/or a cable storage area.

2. The assembly of claim 1, wherein a snap connects the base part to the detachable part.

3. The assembly of claim 1, further comprising a plurality of trays in a stacked array.

4. The assembly of claim 1, wherein the termination panel is in a front facing location on the detachable part.

5. The assembly of claim 1, further comprising a splice holder in a rear portion of the detachable part.

6. The assembly of claim 5, further comprising a divider wall between the termination panel and the splice area and/or the storage area.

7. The assembly of claim 1, further comprising a hinge element positioned on the base part adjacent to a front of the base part.

8. The assembly of claim 1, further comprising a front cover on each tray.

9. The assembly of claim 7, wherein the front cover is separately pivotable relative to the chassis and the tray.

10. The assembly of claim 1, further comprising a latch for latching the tray in a closed/retracted position and in an open/extended position.

11. The assembly of claim 1, wherein the cable storage area is formed partially by the base part and partially by the detachable part, wherein each of the base part and the detachable part includes cable retention tabs positioned over the bottom surfaces of the base part and the detachable part to form a loop storage basket.
